(19) United States
(12) Patent Application Publication
(10) Pub. No.: US 2026/0120616 A1
(43) Pub. Date: Apr. 30, 2026

(54) Electronic Display Horizontal Crosstalk Compensation

(71) Applicant: Apple Inc., Cupertino, CA (US)

(72) Inventors: Kanghwan Kim, Sunnyvale, CA (US); Feng Wen, Santa Clara, CA (US); Hyunsoo Kim, San Diego, CA (US); Hyunwoo Nho, Palo Alto, CA (US); Jie Won Ryu, San Jose, CA (US); Kingsuk Brahma, Mountain View, CA (US); Nicolas Le Dortz, Palo Alto, CA (US); Patrick R Cruce, Campbell, CA (US); Pubudu Galwaduge, Fremont, CA (US); Raymond Liou, Fremont, CA (US); Sachiko Oda, Santa Clara, CA (US); Yao Shi, Sunnyvale, CA (US); Yue Jack Chu, Cupertino, CA (US)

(21) Appl. No.: 19/337,704

(22) Filed: Sep. 23, 2025

Related U.S. Application Data
(60) Provisional application No. 63/711,636, filed on Oct. 24, 2024.

(51) Int. Cl. G09G 3/20

(52) U.S. Cl. CPC G09G 3/2092; G09G 2310/08; G09G 2320/0209; G09G 2330/021

(57) ABSTRACT

Electronic devices, displays, and methods are provided for compensating image data to account for horizontal crosstalk between display pixels on a shared scan line. An electronic display may include an electronic display panel with lines and columns of display pixels. Each row of display pixels may be coupled to a respective scan line. Display driver circuitry may adjust image data associated with the display pixels to account for coupling between the display pixels and the respective scan lines.

This application claims priority to U.S. Provisional Application No. 63/711,636, filed Oct. 24, 2024, which is incorporated by reference herein in its entirety.

### SUMMARY

The present disclosure relates to compensating image data for display on an electronic display to mitigate horizontal crosstalk between display pixels on the electronic display that share a common scan line.

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Numerous electronic devices—such as computers, mobile phones, portable media devices, tablets, televisions, virtual-reality headsets, and vehicle dashboards, among many others—often include electronic displays. To display an image, an electronic display may control light emission of its display pixels based on corresponding image data for the display pixels. By emitting light in various brightness values at different display pixels according to the image data, the electronic display may present an image.

An electronic display is often arranged in rows and columns of display pixels. Each row of display pixels may attach to a scan line shared by all display pixels of that row (e.g., spanning multiple columns). The display pixels may be programmed row by row by scan and/or sampling signals that cause each display pixel of the row to briefly connect to a respective data line. In this way, the display pixels sample the image data (e.g., a particular voltage) that is carried on the data line and then store the image data in the display pixels responsive to a scan signal via the scan line. Because a data line is shared by other display pixels of the same column and/or a scan line is shared by other display pixels of the same row, however, differences in these signals respectively propagating on the data line or scan line could affect the image data that has been stored in a display pixel. This may result in an image artifact in which the brightness of one display pixel could be affected by the image data programmed into subsequent display pixels of the same column due to the shared data line and/or into subsequent display pixels of the same row due to the shared scan line.

To reduce or eliminate these image artifacts, image data for a target display pixel may be adjusted to compensate for differences in image data for subsequently programmed display pixels sharing the same data line and/or sharing the same scan line. For example, crosstalk compensation circuitry (e.g., in an electronic display, in a timing controller) may receive multiple lines of pixel data. Crosstalk between pixels may be determined and associated with a relative weight of crosstalk. The weights may be processed via a weight statistics generator based on pixel zones. Pixel zones may be interpolated and/or otherwise spatially processed to determine weights of crosstalk for each pixel. An offset generator may process the weights of crosstalk for each pixel and generate pixel data adjustment (e.g., compensatory offsets) to be applied to a pixel programming voltage to compensate for crosstalk propagated on the scan line and/or the data line. The pixel data adjustment may be applied (e.g., added) to the target pixel data to generate compensated target pixel data. When this compensated target pixel data is programmed into the target display pixel, after settling, the target display pixel may have reduced or may be substantially free of crosstalk image artifacts (e.g., self-coupling crosstalk).

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an electronic device with an electronic display;

FIG. 2 is a front view of a handheld device representing an example of the electronic device of FIG. 1;

FIG. 3 is a front view of another handheld device representing another example of the electronic device of FIG. 1;

FIG. 4 is a perspective view of a notebook computer representing an example of the electronic device of FIG. 1;

FIG. 5 illustrates front and side views of a wearable electronic device representing another example of the electronic device of FIG. 1;

FIG. 6 is a block diagram of an electronic display having an array of display pixels controlled based on timing controller circuitry that includes crosstalk compensation circuitry;

FIG. 7 is a diagrammatic representation of a respective aggressor zone on proximate regions and example resulting image artifacts;

FIG. 8 is a diagrammatic representation of example parasitic capacitances within a first active area architecture of the electronic display of FIG. 1 and example effects on scan signal;

FIG. 9 is a block diagram of first example crosstalk compensation circuitry;

FIG. 10 is a diagrammatic representation of zone-based compensation processing based on the first example crosstalk compensation circuitry of FIG. 9 relative to the first active area architecture;

FIG. 11 is a diagrammatic representation of zone-based compensation processing based on the first example crosstalk compensation circuitry of FIG. 9 relative to the first active area architecture of the electronic display of FIG. 1 and a subset of weights being generated via a weight statistics generator of the crosstalk compensation circuitry of FIG. 9;

FIG. 12 is a diagrammatic representation of example parasitic capacitances within a second active area architecture of the electronic display of FIG. 1 and example effects on scan signal;

FIG. 13 is a block diagram of second example crosstalk compensation circuitry;

FIG. 14 is a diagrammatic representation of zone-based compensation processing based on the second example crosstalk compensation circuitry of FIG. 13 relative to the second active area architecture; and

FIG. 15 is a diagrammatic representation of zone-based compensation processing based on the second example crosstalk compensation circuitry of FIG. 13 relative to the second active area architecture of the electronic display of FIG. 1 and a subset of weights being generated via a weight statistics generator of the crosstalk compensation circuitry of FIG. 13.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

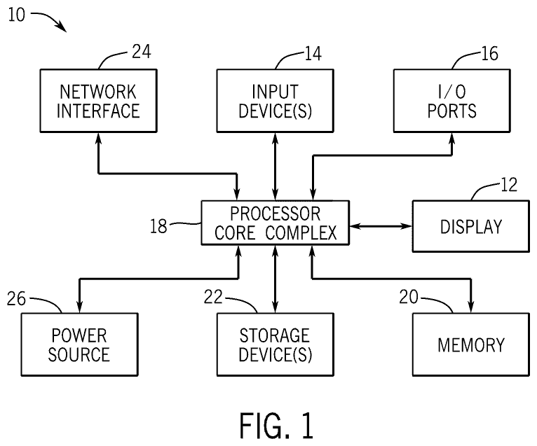

An electronic device 10 including an electronic display 12 is shown in FIG. 1. As is described in more detail below, the electronic device 10 may be any suitable electronic device, such as a computer, a mobile phone, a portable media device, a tablet, a television, a virtual-reality headset, a wearable device such as a watch, a vehicle dashboard, or the like. Thus, it should be noted that FIG. 1 is merely one example of a particular implementation and is intended to illustrate the types of components that may be present in an electronic device 10.

The electronic device 10 includes the electronic display 12, one or more input devices 14, one or more input/output (I/O) ports 16, a processor core complex 18 having one or more processing circuit(s) or processing circuitry cores, local memory 20, a main memory storage device 22, a network interface 24, and a power source 26 (e.g., power supply). The various components described in FIG. 1 may include hardware elements (e.g., circuitry), software elements (e.g., a tangible, non-transitory computer-readable medium storing executable instructions), or a combination of both hardware and software elements. It should be noted that the various depicted components may be combined into fewer components or separated into additional components. For example, the local memory 20 and the main memory storage device 22 may be included in a single component.

The processor core complex 18 is operably coupled with local memory 20 and the main memory storage device 22. Thus, the processor core complex 18 may execute instructions stored in local memory 20 or the main memory storage device 22 to perform operations, such as generating or transmitting image data to display on the electronic display 12. As such, the processor core complex 18 may include one or more general purpose microprocessors, one or more application specific integrated circuits (ASICs), one or more field programmable logic arrays (FPGAs), or any combination thereof.

In addition to program instructions, the local memory 20 or the main memory storage device 22 may store data to be processed by the processor core complex 18. Thus, the local memory 20 and/or the main memory storage device 22 may include one or more tangible, non-transitory, computer-readable media. For example, the local memory 20 may include random access memory (RAM) and the main memory storage device 22 may include read-only memory (ROM), rewritable non-volatile memory such as flash memory, hard drives, optical discs, or the like.

The network interface 24 may communicate data with another electronic device or a network. For example, the network interface 24 (e.g., a radio frequency system) may enable the electronic device 10 to communicatively couple to a personal area network (PAN), such as a Bluetooth network, a local area network (LAN), such as an 802.11x Wi-Fi network, or a wide area network (WAN), such as a 4G, Long-Term Evolution (LTE), or 5G cellular network. The power source 26 may provide electrical power to one or more components in the electronic device 10, such as the processor core complex 18 or the electronic display 12. Thus, the power source 26 may include any suitable source of energy, such as a rechargeable lithium polymer (Li-poly) battery or an alternating current (AC) power converter. The I/O ports 16 may enable the electronic device 10 to interface with other electronic devices. For example, when a portable storage device is connected, the I/O port 16 may enable the processor core complex 18 to communicate data with the portable storage device.

The input devices 14 may enable user interaction with the electronic device 10, for example, by receiving user inputs via a button, a keyboard, a mouse, a trackpad, or the like. The input device 14 may include touch-sensing components in the electronic display 12. The touch sensing components may receive user inputs by detecting occurrence or position of an object touching the surface of the electronic display 12.

The electronic display 12 may include a display panel with an array of display pixels. The electronic display 12 may control light emission from the display pixels to present visual representations of information, such as a graphical user interface (GUI) of an operating system, an application interface, a still image, or video content, by displaying frames of image data. To display images, the electronic display 12 may include display pixels implemented on the display panel. The display pixels may represent sub-pixels that each control a luminance value of one color component (e.g., red, green, or blue for an RGB pixel arrangement or red, green, blue, or white for an RGBW arrangement).

The electronic display 12 may display an image by controlling light emission from its display pixels based on image data associated with corresponding display pixels in the image. In some embodiments, image data may be generated by an image source, such as the processor core complex 18, a graphics processing unit (GPU), or an image sensor. Additionally, in some embodiments, image data may be received from another electronic device 10, for example, via the network interface 24 and/or an I/O port 16. Similarly, the electronic display 12 may display frames based on image data generated by the processor core complex 18, or the electronic display 12 may display frames based on image data received via the network interface 24, an input device, or an I/O port 16.

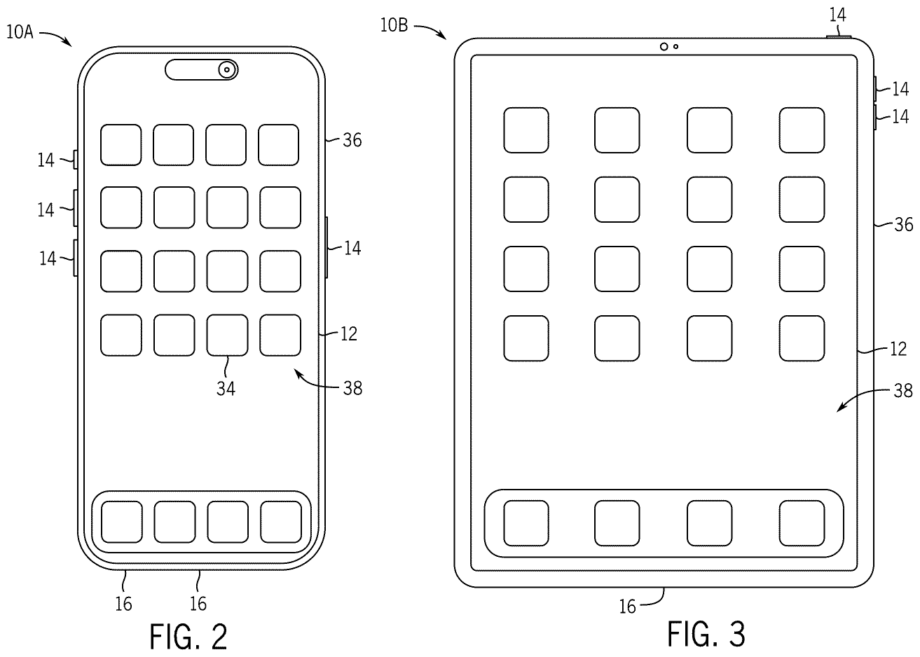

The electronic device 10 may be any suitable electronic device. To help illustrate, an example of the electronic device 10, a handheld device 10A, is shown in FIG. 2. The handheld device 10A may be a portable phone, a media player, a personal data organizer, a handheld game platform, or the like. For illustrative purposes, the handheld device 10A may be a smart phone, such as an IPHONE® model available from Apple Inc.

The handheld device 10A includes an enclosure 36 (e.g., housing). The enclosure 36 may protect interior components from physical damage or shield them from electromagnetic interference, such as by surrounding the electronic display 12. The electronic display 12 may display a graphical user interface (GUI) 38 having an array of icons. When an icon 34 is selected either by an input device 14 or a touch-sensing component of the electronic display 12, an application program may launch.

The input devices 14 may be accessed through openings in the enclosure 36. The input devices 14 may enable a user to interact with the handheld device 10A. For example, the input devices 14 may enable the user to activate or deactivate the handheld device 10A, navigate a user interface to a home screen, navigate a user interface to a user-configurable application screen, activate a voice-recognition feature, provide volume control, or toggle between vibrate and ring modes.

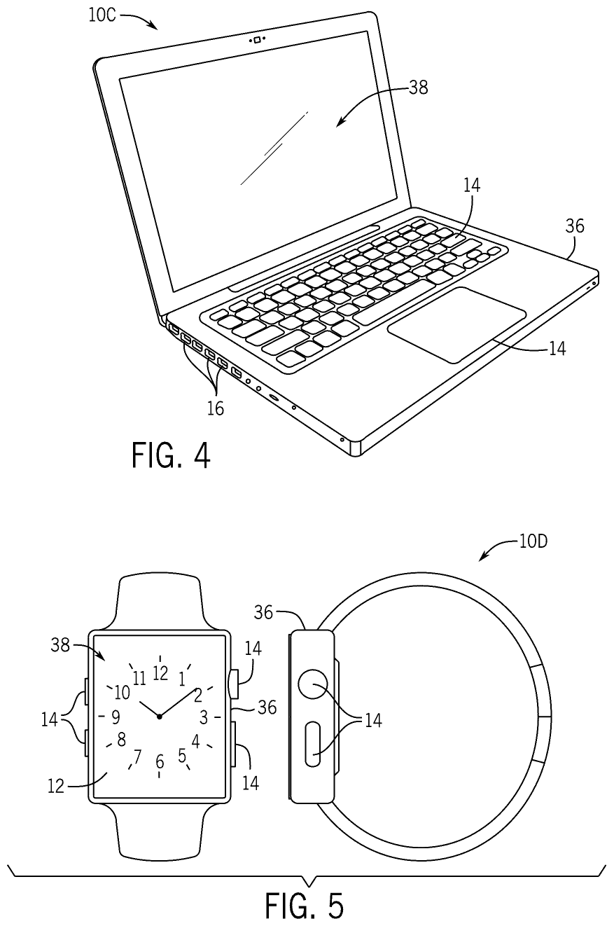

Another example of a suitable electronic device 10, specifically a tablet device 10B, is shown in FIG. 3. The tablet device 10B may be an IPAD® model available from Apple Inc. A further example of a suitable electronic device 10, specifically a computer 10C, is shown in FIG. 4. For illustrative purposes, the computer 10C may be a MACBOOK® or IMAC® model available from Apple Inc. Another example of a suitable electronic device 10, specifically a watch 10D, is shown in FIG. 5. For illustrative purposes, the watch 10D may be an APPLE WATCH® model available from Apple Inc. As depicted, the tablet device 10B, the computer 10C, and the watch 10D each also includes an electronic display 12, input devices 14, I/O ports 16, and an enclosure 36 The electronic display 12 may display a GUI 38. Here, the GUI 38 shows a visualization of a clock. When the visualization is selected either by the input device 14 or a touch-sensing component of the electronic display 12, an application program may launch, such as to transition the GUI 38 to presenting the icons 34 discussed in FIGS. 2 and 3.

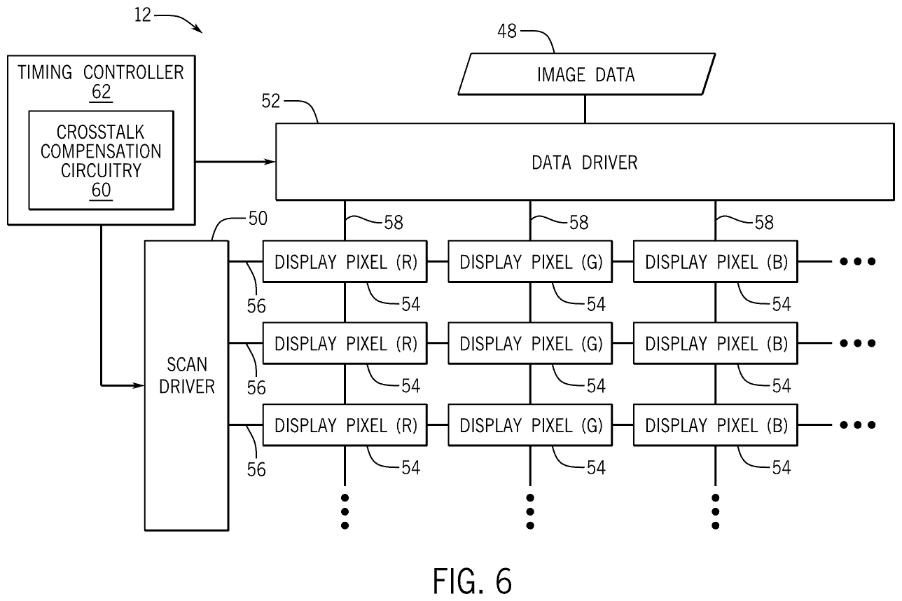

FIG. 6 illustrates one version of the electronic display 12 that may use pixel grouping to increase frame rates without consuming additional power and while preserving image quality. In FIG. 6, the electronic display 12 is shown as an electronic display 12A representing a liquid crystal display (LCD) or an organic light emitting diode (OLED) display. The electronic display 12A may receive image data 48 for display from timing controller 62. The electronic display 12A uses display driver circuitry that includes scan driver 50 and data driver 52 to program the image data 48 onto display pixels 54. The display pixels 54 may each represent a liquid crystal (LC) cell to filter certain colors of light in various brightness levels from a backlight (not shown) or may contain one or more self-emissive elements, such as a light-emitting diodes (LEDs) (e.g., organic light emitting diodes (OLEDs) or micro-LEDs (u LEDs)). The display pixels 54 may also represent pixels of digital mirror devices (DMD) or other suitable display devices. In any event, different display pixels 54 may emit different colors (e.g., red (R), green (G), blue (B), for an RGB display). For example, some of the display pixels 54 may emit red light, some may emit green light, and some may emit blue light. Thus, the display pixels 54 may be driven to emit light at different brightness levels to cause a user viewing the electronic display 12A to perceive an image formed from different colors of light. The display pixels 54 may also correspond to hue and/or luminance levels of a color to be emitted and/or to alternative color combinations, such as combinations that use cyan, magenta, and yellow (CMY), or others.

The scan driver 50 may provide scan signals (e.g., pixel reset, data enable, on-bias stress, scan, data sampling) on scan lines 56 to activate the display pixels 54 by row. For example, the scan driver 50 may cause one or more selected rows of the display pixels 54 to become enabled to receive a portion of the image data 48 from data lines 58 from the data driver 52. As used herein, the portion of image data 48 received by display pixels 54 may be referred to as “image data” or “pixel data.” An image frame of image data 48, containing pixel data for the display pixels 54, may be programmed onto the display pixels 54 row by row or selected groups of rows. Because each row of the display pixels 54 may share one scan line 56, it is possible that self-coupling from the scan line 56 to a display pixel 54 could occur even when that display pixel 54 for some period of time after the display pixel 54 is no longer activated. As such, the electronic device 10 may include crosstalk compensation circuitry 60 to adjust the image data before it is programmed into the display pixels 54 to compensate for scan line-based self-coupling parasitic capacitances. The crosstalk compensation circuitry 60 may apply an adjustment in a linear, gamma domain, or a voltage domain of the image data 48. After adjustment, when programmed into the display pixels 54, image artifacts due to self-coupling crosstalk may be reduced or eliminated. While the crosstalk compensation circuitry 60 is shown in FIG. 6 as a component of a timing controller 62 of the electronic display 12, in other examples, the crosstalk compensation circuitry 60 may be disposed in other circuitry, such as, display driver circuitry (e.g., data driver 52, scan driver 50), image processing circuitry (e.g., a display pipeline) associated with the processor core complex 18, or the like.

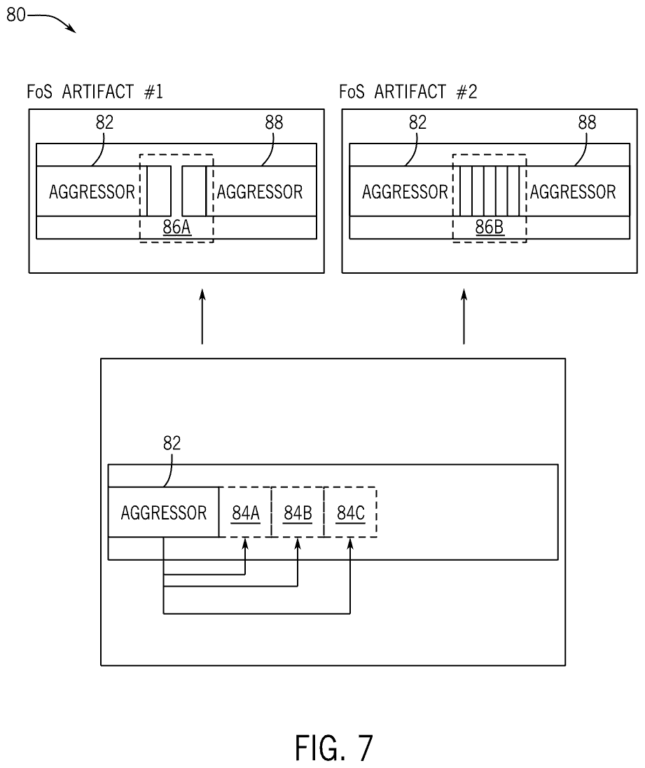

Since the electronic device 10 may include the crosstalk compensation circuitry 60 in the timing controller 62 circuitry, the timing controller 62 may be configurable to adjust image data 48 associated with the display pixels 54 to account for crosstalk between the display pixels 54 and the respective scan lines 56. The timing controller 62 may be configurable to adjust the image data 48 based on image data values associated with adjacently programmed display pixels 54 coupled to the same respective scan line. The timing controller 62 may adjust the image data 48 to be programmed into the display pixels 54 based on a weighted average of a subset of image data values. The timing controller 62 may adjust the image data 48 based on the weighted average of the subset of the image data values interpolated to identify one or more offsets defined for each display pixel 54 of the display pixels 54. The timing controller 62 may include a lookup table that outputs a compensation value associated with a target display pixel 54 based on interpolated weighted averages of the image data values relative to a location of the target display pixel, where the compensation value may be applied to the subset of the image data to be written to the target display pixel 54, causing compensation of one or more image artifacts. These and other operations may be described further herein relative to FIGS. 7-15.

Some electronic display 12 panels may exhibit characteristic front-of-screen (FOS) artifacts. An example FOS artifact may involve hue and/or luminance of one or more display pixels 54 being affected (e.g., victim pixels) by image data presented through one or more nearby display pixels 54 (e.g., aggressor pixels). Among these types of FOS artifacts, there is a type of FOS artifact, horizontal crosstalk, that has a magnitude deterministically affected by image data stored in one or more display pixels 54 that share the same scan line.

A few representative example horizontal crosstalk artifacts the crosstalk compensation circuitry 60 may compensate for are illustrated in FIG. 7. FIG. 7 is a diagrammatic representation 80 of a respective aggressor zone 82 on proximate zones 84 (zone 84A, zone 84B, zone 84C) and example resulting image artifacts 86 (image artifact example 86A, image artifact example 86B).

An aggressor zone 82 may cause horizontal crosstalk on nearby display pixels 54, such as each display pixel 54 that share a same scan line 56. A magnitude of the horizontal crosstalk, however, may vary as a function of distance. As such, the magnitude of the horizontal crosstalk may reduce as a victim display pixel 54 is physically located further on the electronic display 12 panel from a respective aggressor zone 82. For example, the zone 84C may experience less horizontal crosstalk from the aggressor zone 82 relative to the zone 84A or zone 84B. Other aggressor zones may exist, like aggressor zone 88. Although the zone 84C may experience less horizontal crosstalk from aggressor zone 82, the zone 84C may be spatially closer to another aggressor zone (such as aggressor zone 88) and thereby may experience more horizontal crosstalk from that aggressor zone. The collective effect of the various sources of horizontal crosstalk may generate image artifacts 86A.

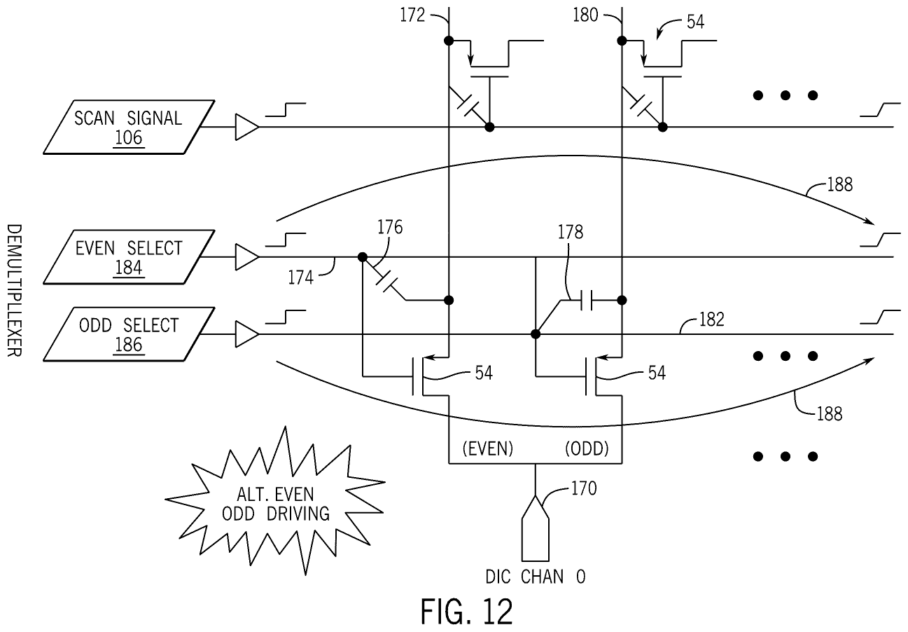

In some displays, a demultiplexer display architecture is used. This, as an example, is described further relative to FIGS. 12-15. Image artifacts 86B is an example of a type of FOS artifact that may be generated through the demultiplexer display architecture. The demultiplexer display architecture operates based on driving even columns of pixels at a different time than odd columns of pixels. Since coupling paths between even columns of pixels may have different parasitic capacitances than coupling paths between odd columns of pixels, an example FOS artifact may emphasize the column structure of the electronic display 12 (e.g., image artifacts 86B) through changes in hue and/or luminance.

As illustrated with image artifacts 86, horizontal crosstalk may degrade the integrity of image content presented via the electronic display 12 based on a misrepresentation of a portion of the hue and/or luminance of the desired image content. Degraded integrity of image content may be undesirable due to its impact on user experience with the electronic device 10 and the potential for inefficient use of computing resources associated with a user mis-interacting with presented image content from artifacts. Thus, it may be desired to compensate for horizontal crosstalk to reduce a perceivability of the FOS artifacts by a user viewing image content presented via the electronic display 12.

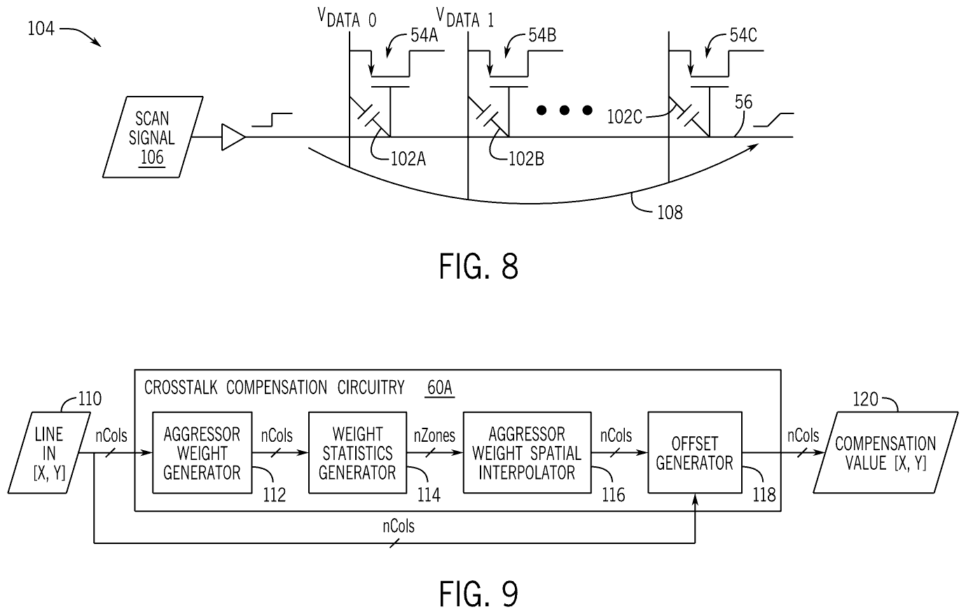

To elaborate, FIG. 8 is a diagrammatic representation of example parasitic capacitances 102 (parasitic capacitance 102A, parasitic capacitance 102B, parasitic capacitance 102C) within a first active area architecture 104 of the electronic display 12 and example effects on scan signal 106 through a transmission via a scan line 56. Parasitic capacitances may exist in respective display pixels 54, including the gate-to-source parasitic capacitance 102. The display pixels 54 are connected to the data line 58 via the source nodes of data write transistors (or a drain node if using N-type transistors as part of the display pixels 54). The pixels 54 are connected to the scan line 56 via the gate nodes of the data write transistors. As a scan signal 106 is transmitted from the scan driver 50 to each of the display pixels 54 in a row, the parasitic capacitances 102 may change the slew rate of the scan signal 106 (e.g., change represented through arrow 108). The slew rate of the scan signal 106 may determine how data line 58 voltages becomes programmed in each display pixel 54, and a discrepancy between the desired data voltage and the programmed data voltage can arise from the slew rate. Therefore, changing the slew rate unintentionally due to parasitic capacitances 102 may result in undesirable pixel data write operation and horizontal crosstalk, such as those illustrated in FIG. 7.

To compensate for horizontal crosstalk, crosstalk compensation circuitry may generate one or more offsets to be applied to image data voltages to compensate for slew rate changes, parasitic capacitances, and the like. The offset may be a voltage or an indication of an image data to use to adjust the image data voltages prior to being used to drive presentation of image content on the electronic display 12. Applying the offset to the image data voltage may occur on a per-pixel basis or for regions of pixels.

To elaborate, FIG. 9 is a block diagram of first example crosstalk compensation circuitry 60A. The crosstalk compensation circuitry 60A may be a relatively low latency digital compensation circuit that may compensate for scan-line-content dependent image artifacts 86 in real time to help improve user experiences with the electronic display 12 and presented image content. The crosstalk compensation circuitry 60A may include digital circuitry that generates compensation values 120 based on an aggressor weight generator 112, a weight statistics generator 114, an aggressor weight spatial interpolator 116, and an offset generator 118. The crosstalk compensation circuitry 60A may be used as part of an image compensation operation (e.g., display pipeline) to improve an integrity of image content presented on the electronic display 12 panel through correction or reduced perceivability of horizontal crosstalk image artifacts 86.

Although an n-col, 1-row geometry is described herein, it should be understood that the crosstalk compensation circuitry 60A may be configurable into any suitable geometry of processing, including individual pixel processing, per-pair-of-pixels processing, per a group of columns of the same parity (e.g., all even columns, all odd columns), per a group of rows of the same parity (e.g., all even rows, all odd rows), or any combination thereof, such that artifacts occurring at a variety of spatial frequencies may be compensated using systems and methods described herein.

The crosstalk compensation circuitry 60A may compensate for hue and/or luminance errors of one or more display pixels 54 in a respective row (e.g., each pixel in a row). To do so, the crosstalk compensation circuitry 60A may receive line in data 110 from image processing circuitry, which may be associated with processor core complex 18. The processor core complex 18 may include display pipeline and/or other image processing circuitry that outputs the line in data 110 after performing some amount of pre-processing of the image data prior to presentation via the electronic display 12. The line in data 110 may include a row array of image data. Variable “X” may correspond to a number of columns of data in the line in data 110 (“nCols”). Variable “Y” may correspond to a number of rows of data in the line in data 110. Line in data 110 may be a row array, and thus Y may equal “1” to indicate one row.

The crosstalk compensation circuitry 60A may generate one or more aggressor weight indications via an aggressor weight generator 112. The aggressor weight generator 112 may receive a line of image data, such as line in data 110, which may correspond to a line (e.g., a row) of display pixels 54. The aggressor weight generator 112 may generate weight data for each portion of image data of the line in data 110. The generated weight data may correspond to aggregated impacts on a scan line slew rate that each display pixel 54 may have throughout the transmission. To say differently, weight data may be respectively generated for each display pixel 54 and may represent a relative impact of that display pixel 54 on the overall scan line slew rate based on a contribution of that display pixel 54 to the crosstalk affecting the scan signal 106.

The aggressor weight generator 112 may generate weight data to represent the contribution of each aggressor display pixel 54 to the horizontal crosstalk.

The weight data may be output from the aggressor weight generator 112 as a row array of size [1:nCol] (e.g., 1 to number of columns) and be received by a weight statistics generator 114. The weight statistics generator 114 may generate weight data statistics based on the spatial distribution of pixel data voltages of the line in data 110 (e.g., the line of image data). The weight data may include respective weight data for each display pixel 54 in the line of display pixels 54 (e.g., a quantity of weight data equal to a number of columns multiplied by a number of rows). The weight statistics generator 114 may generate weight data for each display pixel 54 in the line of display pixels 54, may associate subsets of the weight data into zones 140 of display pixels 54, may average the subsets of the weight data within each zone of the zones, and may send the averaged weight data to the aggressor weight spatial interpolator 116 before using the averaged weight data to, via the offset generator 118, determine per-pixel compensation values 120 based on interpolating the averaged subsets of the weight data.

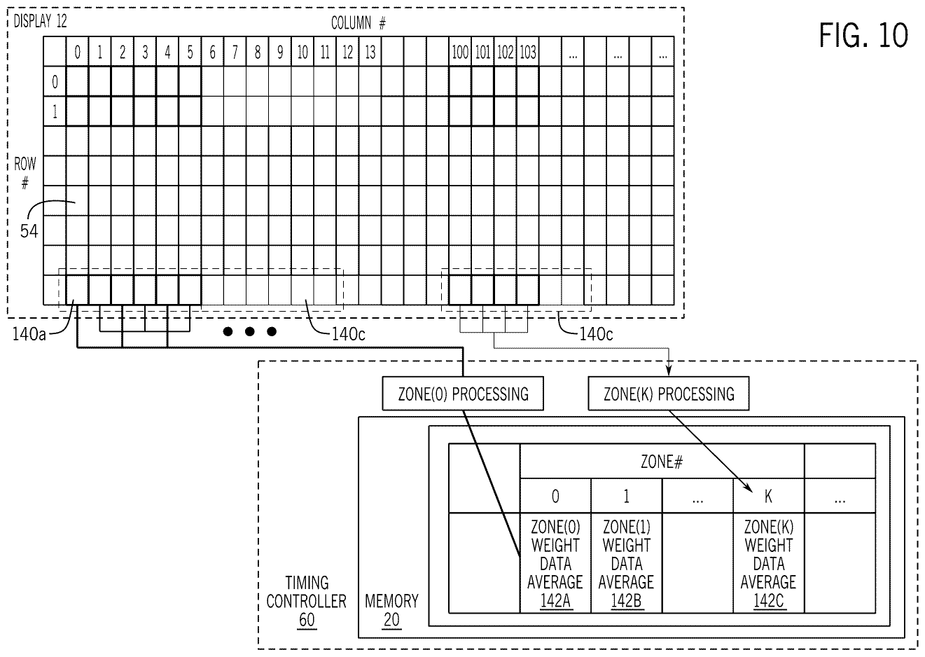

The weight statistics generator 114 may average weight data based on zones of display pixels 54, or processing subsets of display pixels 54. Zones are generally illustrated in FIG. 10 as zones 140 (zone 140A, zone 140B, zone 140C). Referring briefly to FIG. 10, FIG. 10 is a diagrammatic representation of zone-based compensation processing based on the first example crosstalk compensation circuitry 60A relative to the first active area architecture of the electronic display 12. Matrix data structure 144 may include columns and rows of weight data that may correspond to magnitudes of crosstalk for different locations and/or display pixels 54 of the display 12. The weight data of the matrix data structure 144 may correspond to an aggregate of aggressor weight of influence experienced by a victim display pixel 54 at that particular location. Display pixels 54, and thus weight data corresponding to the display pixels 54, may be associated by the crosstalk compensation circuitry 60A into respective zones 140. Weight data associated within each zone may be averaged across the zone 140, such that each zone 140 corresponds to averaged weight data values 142 (averaged weight data value 142A, averaged weight data value 142B, averaged weight data value 142C). Zone-based processing may balance accuracy with computational cost, enabling relatively accurate interpolation operations to generate per-pixel values at a later time while reducing computational costs by increasing a granularity of processing of weight data.

In this example, the zones 140 are the same size (e.g., number of display pixels 54). However, in some examples, zone 140 sizes are configurable and/or non-uniform. Having non-uniform or asymmetrical sized zones may increase computational cost. However, using non-uniform or asymmetrical sized zones may increase accuracy of computation, which may be desired in some systems.

Referring back to FIG. 9, an aggressor weight spatial interpolator 116 may receive average weight data values 142 corresponding to each zone. The average weight data values 142 may take into account victim zones that are located closer to aggressor zones having relatively higher magnitudes of averaged weight data values 142. A matrix of weights may be generated to reflect the effect of the relative locations of the aggressors display pixels and victim display pixels Example of these matrixing operations may be generally illustrated in FIGS. 10, 11, 14, and 15. As crosstalk contributions are aggregated per pixel location, different values within the matrix may be relatively greater than other locations based on relative crosstalk experienced at those different locations. The aggressor weight spatial interpolator 116 may then interpolate one or more respective average weight data values 142 to determine weight data corresponding to respective display pixels 54. By interpolating average weight data values 142, the crosstalk compensation circuitry 60A may determine compensation values 120 for respective display pixels 54 without having to perform or maintain calculations for each respective display pixel 54. Interpolating average weight data values 142 corresponding to zones may also enable smooth transition between zones 140.

The offset generator 118 may determine compensation values 120. The offset generator 118 may generate compensation values 120 based on the line in data 110 and extracted per-pixel averaged weight data from the aggressor weight spatial interpolator 116. Compensation values 120 may be an indication of an offset to be applied to image data to compensate and/or remove effects of crosstalk from image content being presented. The offset generator 118 may identify, based on the weight data, compensation values 120 to be used to adjust respective image data of the line of image data before being applied to a target display pixel in the line of display pixels. The offset generator 118 may include a lookup table. The offset generator 118 may query the lookup table, which may return compensation values 120 based on interpolated weighted averages of the image data values relative to the location of the target display pixel. The lookup table may be a three-dimensional lookup table. By calculating how much impact an aggregate of aggressor zone 82 to that an individual pixel location will be and the actual voltage of the pixel to be programmed will be, the offset generator 118 may determine a voltage pixel correction to be applied to image data reach the desired luminance, compensating for crosstalk or reducing a perceivability of the effects of the crosstalk.

In some systems, the crosstalk compensation circuitry 60A couples to addition circuitry configured. The crosstalk compensation circuitry 60A may output compensation values 120 to the addition circuitry. The addition circuitry may add the compensation values 120 to the corresponding portions of the image data of the line of image data before being programmed into the line of display pixels 54. For example, applying, via the crosstalk compensation circuitry, the first compensation value to the first pixel data before the first pixel data is programmed into the first display pixel of the electronic display may be based on the addition circuitry operating to add the first compensation value to the first pixel data.

The aggressor weight generator 112 may generate weights based on a relationship between voltage data being programmed to each display pixel 54 and between scan signal 106 slew rate. When the relationship between the two is not well defined, the aggressor weight generator 112 may use a default function to determine a function that anticipates an impact of the voltage data being programmed to each display pixel 54 onto scan signal 106 transmitted via a shared scan line 56. The aggressor weight generator 112 may map a voltage being programmed to one or more pixels 54 into an impact estimator. The impact estimator may access an indication of spatial distance between victim pixels and aggressor pixels. The weight statistics generator 114 may determine an average of multiple zones 140 based on the weight data output from the aggressor weight generator 112. The weight statistics generator 114 may calculate the average by each zone 140. Zones 140 may be used because calculation pixel-by-pixel may yield an undesirably large dataset for cost effective crosstalk weight aggregations and/or matrix operations. Zones 140 may be used since use of zones may reduce area used to implement crosstalk compensation, may reduce power consumption since fewer computing resources may be consumed during calculation, and/or may reduce or maintain calibration cost since logistically implementing crosstalk compensation based on zones 140 may be relatively more straightforward than other systems or methods of crosstalk compensation.

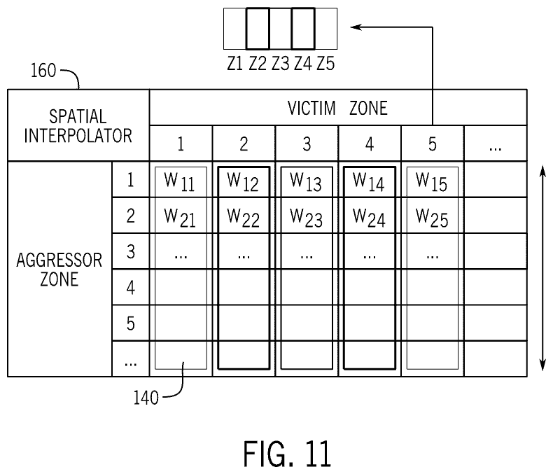

FIG. 11 is a diagrammatic representation of the aggressor weight spatial interpolator 116 performing zone-based compensation processing based on the first example crosstalk compensation circuitry 60A relative to the first active area architecture of the electronic display 12 and a subset of weights being generated via a weight statistics generator of the crosstalk compensation circuitry 60A. Matrix 160 may illustrate the relative strengths of the aggregated effects of aggressor zones have on victim zones. As an example, weight 1-to-1 (W11) may be a coefficient that needs to be multiplied to the scale the aggregate weight of aggressor zone 1 crosstalk contribution as expected to interfere with victim zone 1.

In some systems, a demultiplexer architecture may be used in the electronic display 12. An example of this is shown in FIG. 12. FIG. 12 is a diagrammatic representation of example parasitic capacitances within a second active area architecture of the electronic display 12 (e.g., demultiplexer architecture) and example effects on column select signals 184, 186. In a demultiplexer architecture, columns of pixels may be driven at different times. For example, a column driver 170 may drive odd columns at a first time after enabling the odd columns for use via sending an odd select signal 186 and may drive even columns at a second time after enabling the even columns for use via sending an even select signal 184. This may enable fewer column drivers 170 to be used to perform similar displaying operations since half a typical quantity of column drivers 170 may be used to drive a same number of even and odd rows within the first display architecture. All odd columns may be driven at a partially overlapping time relative to each other without overlapping on even column driving. All even columns may be driven at a partially overlapping time relative to each other without overlapping on odd column driving.

Driving even and odd columns at different times may lead to different columns being affected by different amounts of crosstalk. Crosstalk may affect slew rates of column select signals 184, 186 in a similar manner to scan signals 106 (e.g., generally illustrated through arrows 188. For example, a display pixel 54 in an even column 172 may couple to an even column select line 174 and its source node through a parasitic capacitance 176 associated with the crosstalk. The parasitic capacitance 176 may be different from a parasitic capacitance 178 between a source node of a display pixel 54 in an odd column 180 and an odd scan line 182. Due to this difference in crosstalk between columns, slew rates and programming image data may change by different amounts throughout the row of display pixels 54. This may warrant different compensations being applied to display pixels 54 in even columns versus display pixels 54 in odd columns, and moreover to victim display pixels 54 based on positioning within pixel row relative to aggressor display pixel 54, to reduce the perceivability of artifacts like artifact 86B. For example, a generated compensation value 120, when applied to image data for the display pixel 54 in the odd column 180, may adjust the luminance of the image data to obscure the column artifact contribution from the parasitic capacitance 178 (e.g., artifact 86B of FIG. 7).

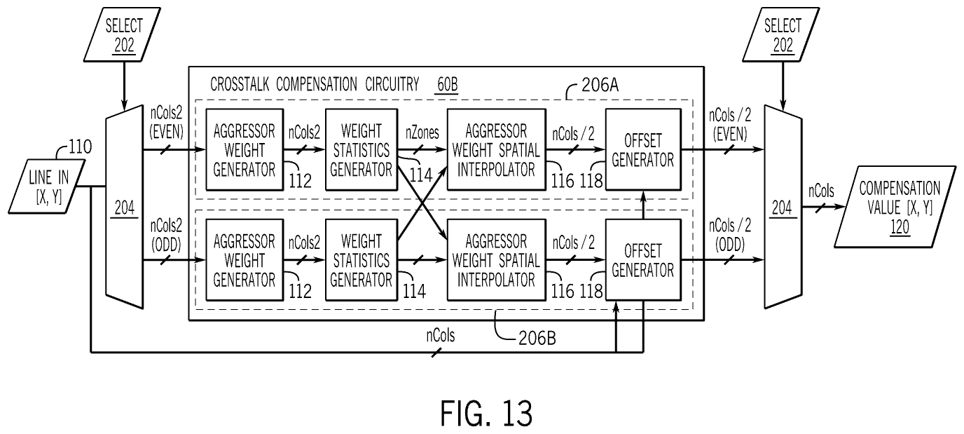

Crosstalk compensation circuitry 60A may be adapted to generate compensation values 120 to compensate for parasitics like parasitic capacitances 176, 178 on a per-column basis. FIG. 13 is a block diagram of second example crosstalk compensation circuitry 60B. The crosstalk compensation circuitry 60B may operate similar to the crosstalk compensation circuitry 60A and perform processing to compensate for different crosstalk between column lines as well as between different display pixels 54. Doing so may involve the crosstalk compensation circuitry 60B adjusting odd column compensation values based on even column weight data averages determined based on zones.

The crosstalk compensation circuitry 60B may receive line in data 110. A select signal 202 may operate multiplexing circuitry 204 to toggle between receiving even column data at the crosstalk compensation circuitry 60B and between receiving odd column data at the crosstalk compensation circuitry 60B.

The crosstalk compensation circuitry 60B may include processing paths 206 (processing path 206A, processing path 206B) for odd and even columns. The processing path 206A may include aggressor weight generator 112A, weight statistics generator 114A, aggressor weight spatial interpolator 116A, and offset generator 118A, which may respectively process even column data. The processing path 206B may include aggressor weight generator 112B, weight statistics generator 114B, aggressor weight spatial interpolator 116B, and offset generator 118B, which may respectively process odd column data. Based on processing operations of these respective processing paths 206 and data exchanged between even processing path 206A and odd processing path 206B at aggressor weight spatial interpolators 116, a compensation value for each display pixel 54 may be generated. The compensation value for each display pixel 54 may be a function of the spatially interpolated weighted average of row contents, on which the weights for the contents on even and odd columns may be assigned accordingly, and the pixel voltage.

As described above, aggressor weight generators 112, weight statistics generators 114, and/or offset generators 118 may use table look-up operations or determinations based on multivariate relationships between inputs. For example, the aggressor weight generators 112 may generate the weight data based on a first look-up table when the line of display pixels 54 is an even row and based on a second look-up table when the line of display pixels 54 is an odd row. The look-up tables and/or the multivariate relationships may enable different methods and values to be used for even and odd columns compensations, depending on the characteristics and severity of the FOS artifacts. In some systems, the offset generators 118 may use a different calculation method (e.g., look-up tables or multivariate equation calculation) than aggressor weight generators 112. In some systems, different calculation methods may be applied between the even processing path 206A and the odd processing path 206B.

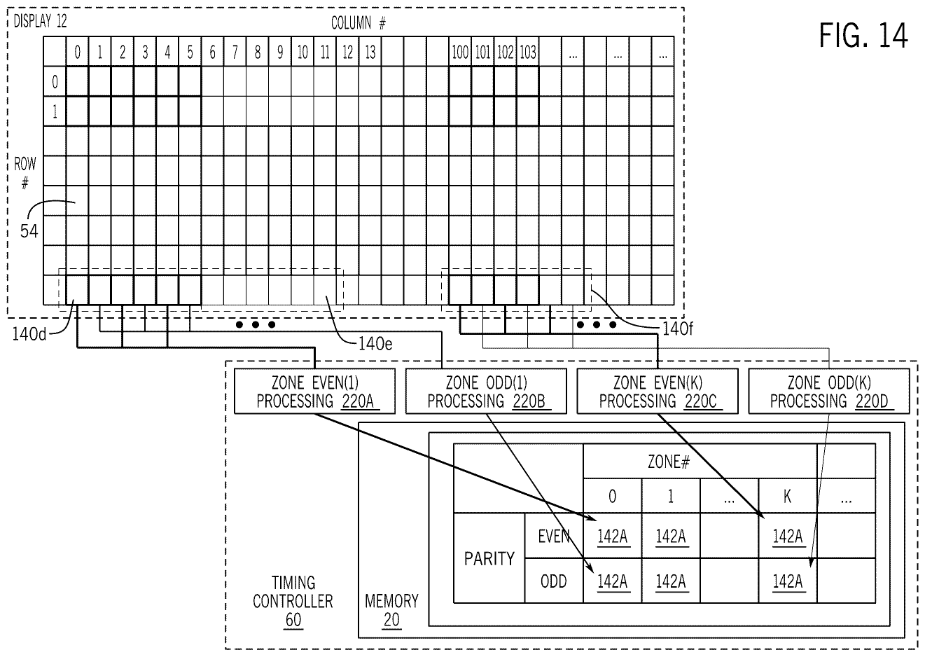

Additional details regarding zone-based processing of the weight statistics generators 114 of FIG. 13 may be described relative to FIG. 14. FIG. 14 is a diagrammatic representation of zone-based compensation processing based on the second example crosstalk compensation circuitry 60B relative to the second architecture of the electronic display 12. Matrix data structure 222 may include columns and rows of weight data that may correspond to magnitudes of crosstalk for different locations and/or display pixels 54 of the display 12. The weight statistics generators 114 may perform respective processing operations to generate averaged weight data values 142. The weight statistics generator 114 in the even processing path 206A may perform even processing operations 220A, 220C. The weight statistics generator 114 in the odd processing path 206B may perform odd processing operations 220B, 220D. The weight statistics generators 114 may average weight data on a per-zone basis and per-column basis. The weight statistics generators 114 may write resulting averaged weight data (e.g., zone-based averaged weight data values 142) to memory 20. The respective aggressor weight spatial interpolators 116 may read the averaged weight data values 142 from the memory 20 to apply the per-zone basis and per-column basis generated averages at the interpolation processing to extrapolate per-pixel data to supply to the offset generators 118.

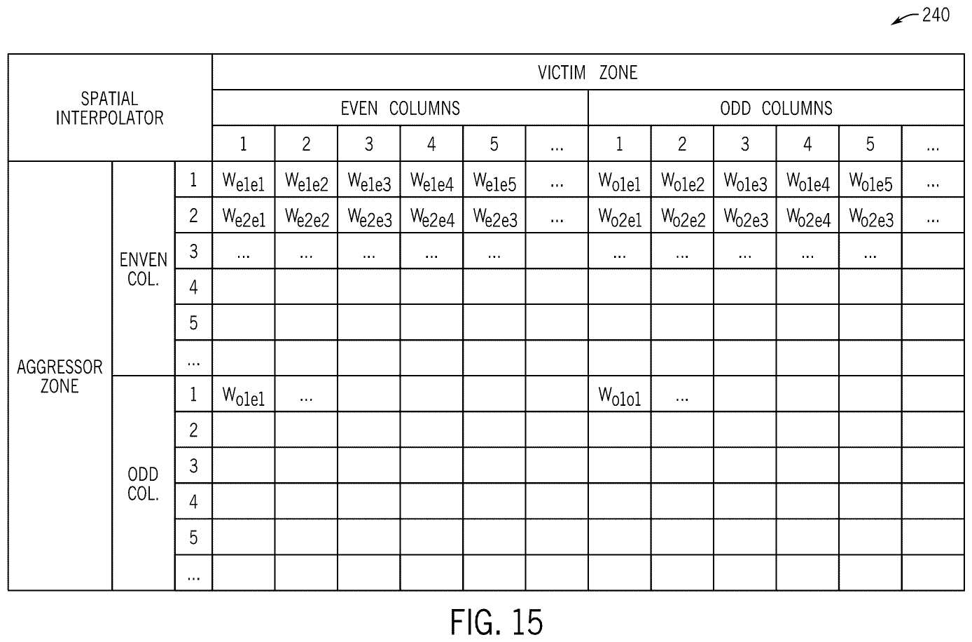

An example of the weight coefficients stored in a matrix data structure is illustrated in FIG. 15. FIG. 15 is a diagrammatic representation of zone-based compensation processing based on the second example crosstalk compensation circuitry 60B relative to the second active area architecture of the electronic display 12 and a subset of weights being generated via a weight statistics generator 114 of the crosstalk compensation circuitry 60B. Matrix 240 may illustrate the relative strengths of the aggressor zones on victim zones. As an example, Weight even 1-to-even 1 (We1e1) may be a coefficient that needs to be multiplied to the scale the aggregate weight of aggressor zone 1 crosstalk contribution as expected to interfere with victim zone 1, on a per even-column-only basis. The coefficients stored in the matrix 240, regardless of the column parity (e.g. Wo1e1) corresponds to an aggregate effect on crosstalk that the pixels of a parity in each zone has on the pixels of a parity in each other zone, which may include different amounts of crosstalk based on where spatially within the electronic display 12 the respective zones are included. In order words, the coefficients stored in the matrix 240 correspond to an aggregate effect on total crosstalk that a unit aggressor in each zone has a unit victim on each other zone, which may include different amounts of crosstalk based on where spatially within the electronic display 12 the respective zones are included. Zone-based averages may be determined and used to extrapolate the per-pixel impact from aggregate crosstalk through interpolation operations of the offset generators 118.

In some systems, the weight statistics generator 114 may generate line averages based on interpolation operations, line averaging operations, and line buffering operations. Interpolation operations may be adjusted based on the line in data 110 and a global display brightness value (DBV) indication. The DBV indication may be received via input device 14 and may correspond to a global brightness adjustment to be applied to an image data presented via the electronic display 12. The DBV indication may increase when the electronic device 10 is physically within a room with low amounts of ambient light and decreases when in a room with high amounts of ambient light. The line averaging operations may be performed on a per-column basis. Thus, the weight statistics generator 114 may generate weighted average data for even columns and weighted average data for odd columns. The line averaging operations may be based on any number of lines, such as one rows or two rows of display pixels 54. A line buffer may be used to transmit the line in data 110 to the offset generator 118 when receiving at the aggressor weight generator 112.

Zoned weighted averages generated based on the line averaging and interpolator operations may be provided to the aggressor weight spatial interpolator 116. The aggressor weight spatial interpolator 116 may apply gain coefficients to the averaged weight data values 142 at spatial interpolation operations to identify weight values from which per-pixel compensation values may be generated. The gain coefficients and the averaged weight data values 142 may be 8-bit values to correspond to the image data depth. The averaging operations may average across sub-pixels (e.g., red (R), green (G), blue (B) sub-pixels, hue (H), saturation(S), value (V) sub-pixels), which may help reduce weight data being processed by at least a third. The interpolation operations may extrapolate per-pixel compensation values across sub-pixels and across various locations of the panel, which may increase data being processed between the weight statistics generator 114 and the offset generator 118 by at least a third. When processing is occurring based on even and odd columns respectively, such as through crosstalk compensation circuitry 60A, these interpolation operations may also be applied on a per-column or per line basis, which may change which gain coefficients are applied to determine the compensation values 120.

In some systems, line in data 110 is processed in raster order. This may enable the crosstalk compensation circuitries 60 to discard the line in data 110 after using the data at the offset generator 118, as opposed to maintaining the line in data 110 for application to the display pixels 54 themselves. In some systems, the crosstalk compensation circuitries 60 perform the compensation in line with other image processing operations, which may mean that the line in data 110 is not discarded and is instead retained and used to program the display pixels 54 after the compensation values 120 are applied. A frame buffer may be used to access the line in data 110, and in these cases, the crosstalk compensation circuitries 60 may perform a frame buffer pass over operation to read a copy of the line in data 110 for processing. The crosstalk compensation circuitries 60 may cause an adjustment of the image data stored in the frame buffer with the compensation values 120, causing the compensation of the horizontal crosstalk associated with scan line parasitics.

It is noted that zones 140 may be defined horizontally, spanning the display pixel 54 rows, not vertically (e.g., spanning the display pixel 54 columns). A zone 140 may be one or more lines of display pixels 54.

With the foregoing in mind, an example electronic device 10 may receive, via crosstalk compensation circuitry 60, first pixel data corresponding to a display pixels 54 of a first line coupled to a first scan line 56 of an electronic display 12. The electronic device 10 may receive, via the crosstalk compensation circuitry 60, data indicating a number of columns that the first scan line spans of the electronic display. The electronic device 10 may determine, via the crosstalk compensation circuitry 60, a first compensation value 120 based on an interpolation of weight data associated with two or more zones of display pixels 54. Determining the first compensation value 120 may involve determining, as part of the weight data, a contribution of the first display pixel 54 to a slew rate distortion. The electronic device 10 may determine, via the crosstalk compensation circuitry 60, the first compensation value 120 based on the interpolation of the weight data associated with the two or more zones 140 of display pixels 54, including a linear interpolation perform along data associated with the first line of display pixels 54. The interpolation of the weight data may include generating weighted averages per zone 140 of display pixels 54 and interpolating between zones 140 of display pixels 54 to identify per-pixel compensation values 120. The interpolation of the weight data may include generating weighted averages per zone 140 of display pixels 54 and interpolating between zones 140 of display pixels 54 to identify per-pixel compensation values 120. In some electronic devices 10, generating weighted averages includes generating the weighted averages based on different coefficients for even rows of display pixels 54 relative to odd rows of display pixels 54. Indeed, identifying per-pixel compensation values 120 may include determining, via the crosstalk compensation circuitry 60, the first compensation value 120 based on an interpolation of the weight data based on a global display brightness value. In some systems, the crosstalk compensation circuitry 60 may include or be software applications, where the electronic device 10 may store instructions in a computer-readable medium that, when executed by processor core complex 18 circuitry, cause the timing controller 62 to perform one or more operations.

Technical effects described herein include systems and methods to compensate for horizontal crosstalk that may arise from parasitic capacitances between rows of display pixels associated in a same scan line. The parasitic capacitances may change in value based on image data being used to program the display pixels. An electronic device may compensate and mitigate the effect of this horizontal crosstalk by determining crosstalk contribution weight data based on image data, averaging the weight data based on pixel zones, and interpolating to identify per-pixel compensation values. In some systems, crosstalk contribution weight data may collapse differences in values between sub-pixels or color channels (e.g., R/G/B, H/S/V). To reestablish data sets of this granularity, the electronic device may do so as part of the interpolation operation to expand the data set. Reducing the image data dataset size for processing may lead to more efficient resource consumption during process, lower amounts of power being consumed, among other benefits. Applying these per-pixel compensation values to the image data prior to the image data being used to drive the display may cause compensation of one or more image artifacts or at least a reduction in perceivability of the image artifacts.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An electronic display comprising:
an electronic display panel comprising lines and rows of display pixels, wherein each row of display pixels is coupled to a respective scan line; and
timing controller circuitry configured to adjust image data associated with the display pixels to account for coupling between the display pixels and the respective scan lines.

2. The electronic display of claim 1, wherein the timing controller circuitry is configured to adjust the image data based on image data values associated with adjacently programmed display pixels coupled to a same respective scan line.

3. The electronic display of claim 2, wherein the timing controller circuitry is configured to adjust the image data based on a weighted average of a subset of the image data values.

4. The electronic display of claim 3, wherein the timing controller circuitry is configured to adjust the image data based on the weighted average of the subset of the image data values interpolated to identify one or more offsets defined for each pixel of the display pixels.

5. The electronic display of claim 2, wherein the timing controller circuitry comprises a lookup table that outputs a compensation value associated with a target display pixel based on interpolated weighted averages of the image data values relative to a location of the target display pixel, wherein the compensation value is configured to be applied to the image data to be written to the target display pixel, causing compensation of one or more image artifacts.

6. Image processing circuitry comprising:
aggressor weight generator circuitry configured to receive a line of image data corresponding to a line of display pixels of an electronic display;
weight statistics generator circuitry configured to generate weight data based on pixel data voltages of the line of image data, wherein a respective weight data is generated for each pixel in the line of display pixels; and
offset generator circuitry configured to identify, based on the weight data, compensation values to be used to adjust respective image data of the line of image data before being applied to a target display pixel in the line of display pixels.

7. The image processing circuitry of claim 6, wherein the respective weight data corresponds to a relative impact of a respective pixel data voltage for that pixel is expected to have on a scan line slew rate.

8. The image processing circuitry of claim 6, wherein the weight statistics generator circuitry is configured to generate the weight data based on a first look-up table when the line of display pixels is an even column and based on a second look-up table when the line of display pixels is an odd column.

9. The image processing circuitry of claim 6, wherein the offset generator circuitry comprises a lookup table that outputs the compensation values based on interpolated weighted averages of image data values relative to a location of the target display pixel.

10. The image processing circuitry of claim 6, wherein the weight statistics generator circuitry is configured to:
generate weight data for each display pixel in the line of display pixels;
associate subsets of the weight data into zones of display pixels;
generate averaged weight data based on the calculation of weighted averaging the subsets of the weight data within each zone of the zones; and
send the averaged weight data to the offset generator circuitry configured to determine per-pixel compensation values based on interpolating the averaged subsets of the weight data.

11. The image processing circuitry of claim 6, comprising addition circuitry configured to add the compensation values to the image data of the line of image data before being programmed into the line of display pixels.

12. A method comprising:
receiving, via crosstalk compensation circuitry, first pixel data corresponding to a first display pixel of a first line of a plurality of display pixels coupled to a first scan line of an electronic display;
receiving, via the crosstalk compensation circuitry, data indicating a number of columns that the first scan line spans of the electronic display;
determining, via the crosstalk compensation circuitry, a first compensation value based on an interpolation of weight data associated with two or more zones of display pixels; and
applying, via the crosstalk compensation circuitry, the first compensation value to the first pixel data before the first pixel data is programmed into the first display pixel of the electronic display.

13. The method of claim 12, wherein determining the first compensation value comprises determining, as part of the weight data, a contribution of the first display pixel to a slew rate distortion.

14. The method of claim 12, wherein determining, via the crosstalk compensation circuitry, the first compensation value based on the interpolation of the weight data associated with the two or more zones of display pixels comprises linear interpolation along the first line.

15. The method of claim 14, wherein the interpolation of the weight data comprises generating weighted averages per zone of display pixels and interpolating between zones of display pixels to identify per-pixel compensation values.

16. The method of claim 15, wherein generating weighted averages comprises generating the weighted averages based on different coefficients for even columns of display pixels relative to odd columns of display pixels.

17. The method of claim 12, comprising determining, via the crosstalk compensation circuitry, the first compensation value based on the interpolation of the weight data and based on a global display brightness value.

18. The method of claim 12, wherein the weight data corresponds to a relative impact of a respective pixel data voltage for that pixel is expected to have on a scan line slew rate.

19. The method of claim 12, wherein the method is performed in timing controller circuitry of the electronic display.

20. The method of claim 19 being performed based on instructions stored in a computer-readable medium that, when executed by processing circuitry, cause the timing controller circuitry of the electronic display to perform one or more operations of the method.
